(19) United States
(12) Patent Application Publication
(10) Pub. No.: US 2014/0152607 A1
(43) Pub. Date: Jun. 5, 2014

(54) TOUCH-SENSING DEVICE USING SELF-SENSING SIGNALS TO IMPLEMENT PROXIMITY DETECTION FUNCTION AND RELATED PROXIMITY DETECTION METHOD THEREOF

(71) Applicant: HIMAX TECHNOLOGIES LIMITED, Tainan City (TW)

(72) Inventors: Chin-Lin Lee, Tainan City (TW); Shen-Feng Tai, Tainan City (TW); Jui-Ming Liu, Tainan City (TW); Cheng-Feng Hsieh, Tainan City (TW)

(73) Assignee: HIMAX TECHNOLOGIES LIMITED, Tainan City (TW)

(21) Appl. No.: 13/705,133

(22) Filed: Dec. 4, 2012

(51) Int. Cl. G06F 3/044

(52) U.S. Cl. CPC G06F 3/044
USPC 345/174

(57) ABSTRACT

A touch-sensing device with a proximity detection function includes a capacitive touch panel and a control circuit. The capacitive touch panel is arranged for generating a plurality of self-sensing signals via a plurality of traces, respectively. The control circuit is coupled to the capacitive touch panel, and arranged for receiving the plurality of self-sensing signals from the capacitive touch panel, and determining whether there is an object approaching the capacitive touch panel according to the plurality of self-sensing signals.

### BACKGROUND OF THE INVENTION

1. Field of the Invention

The present invention relates to proximity sensing technology, and more particularly, to a touch-sensing device using self-sensing signals to implement a proximity detection function and related proximity detection method thereof.

2. Description of the Prior Art

With the advance of science and technology, consumer electronic products, such as personal digital assistants (PDA) and mobile phones, have exploited widespread use of touch panels as their operational interfaces/user interfaces. However, a mobile phone with a touch display is prone to making inadvertent dials when a user holds the mobile phone near his/her face. A common solution is to make use of a proximity sensor to detect whether someone's face (or other objects) is near a touch-sensitive electronic product. The proximity sensor is usually implemented by an infrared LED emitter and receiver pair, or by an extra metal/ITO sensor. If there is an object approaching the touch-sensitive electronic product being detected, the touch-sensitive electronic product will turn off the touch display or the touch control functionality.

However, an additional proximity sensor will increase the product cost. Therefore, there is a need for a touch-sensing device having a proximity detection function without using additional proximity sensors.

### SUMMARY OF THE INVENTION

In accordance with exemplary embodiments of the present invention, a touch-sensing device using self-sensing signals to implement a proximity detection function and related proximity detection method thereof are proposed to solve the above-mentioned problem.

According to an aspect of the present invention, an exemplary touch-sensing device with a proximity detection function is disclosed. The exemplary touch-sensing device includes a capacitive touch panel and a control circuit. The capacitive touch panel is arranged for generating a plurality of self-sensing signals via a plurality of traces, respectively. The control circuit is coupled to the capacitive touch panel, and arranged for receiving the plurality of self-sensing signals from the capacitive touch panel, and determining whether there is an object approaching the capacitive touch panel according to the plurality of self-sensing signals.

According to another aspect of the present invention, an exemplary touch-sensing method is disclosed. The exemplary proximity detection method includes receiving a plurality of self-sensing signals from a capacitive touch panel; and determining whether there is an object approaching the capacitive touch panel according to the plurality of self-sensing signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch-sensing device with a proximity detection function according to an embodiment of the present invention.

FIG. 2 is a schematic diagram illustrating the decision making of the control circuit according to an embodiment of the present invention.

FIG. 3 is a flowchart of a proximity detection method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically coupled to another device, that connection may be through a direct electrical connection, or through an indirect electrical connection via other devices and connections.

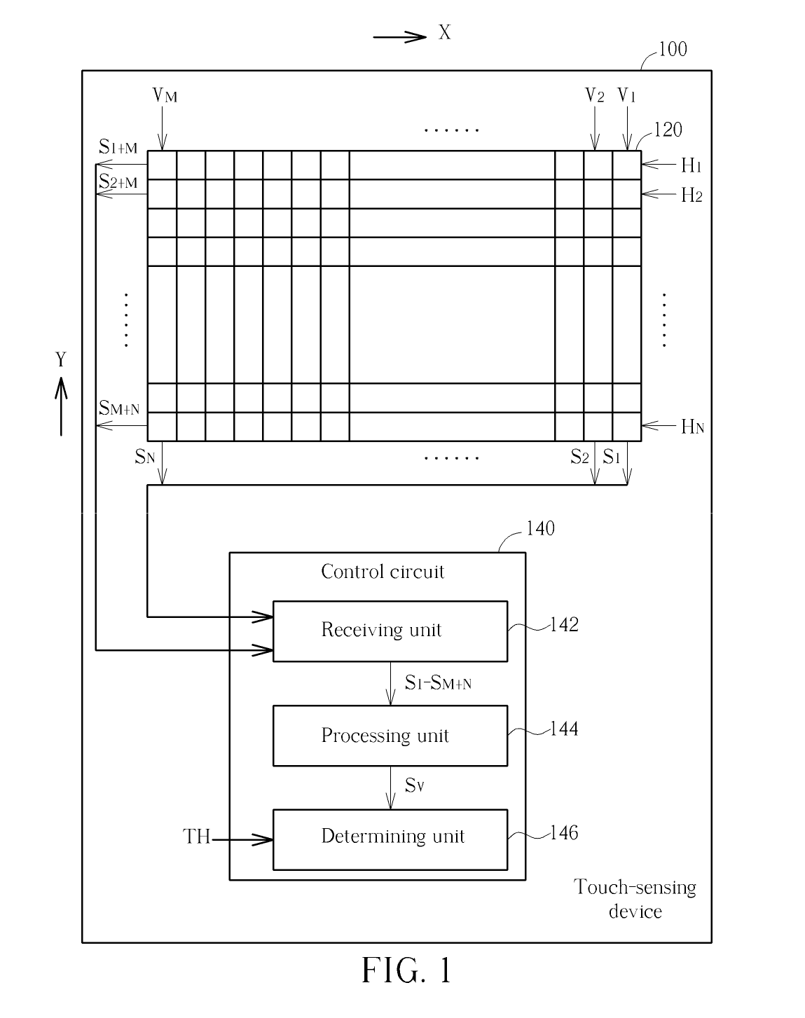

Please refer to FIG. 1, which is a schematic diagram illustrating a touch-sensing device 100 with a proximity detection function according to an embodiment of the present invention. The touch-sensing device 100 includes, but not limited to, a capacitive touch panel 120 and a control circuit 140. The touch-sensing device 100 may be a smart-phone or a personal digital assistant (PDA), and the capacitive touch panel 120 is arranged to act as an interactive user interface such that the touch-sensing device 100 supports a user interface function. For example, the capacitive touch panel 120 may generate an input signal to the touch-sensing device 100 in response to a user's touch on the capacitive touch panel 120. In addition, the touch-sensing device 100 may further include a display for showing a result in response to the input signal.

In this embodiment, the capacitive touch panel 120 includes a plurality of traces H₁-H_{N} and V₁-V_{M}. The traces H₁-H_{N} are arranged and aligned in a first direction X, while the traces V₁-V_{M} are arranged and aligned in a second direction Y. The first direction X and the second direction Y are not parallel. For example, the first direction X is perpendicular to the second direction Y. The traces H₁-H_{N} and the traces V₁-V_{M} are intersected with one another. However, the traces H₁-H_{N} and the traces V₁-V_{M} are not coplanar. In this way, each of the traces H₁-H_{N} will not directly contact with any of the traces V₁-V_{M}, and vice versa. Under this configuration, each of the plurality of traces H₁-H_{N} and V₁-V_{M} serves as an independent self-capacitance sensor, and therefore the plurality of traces H₁-H_{N} and V₁-V_{M} are utilized for generating a plurality of self-sensing signals S₁-S_{M+N}, respectively. Please note that the plurality of traces H₁-H_{N} and V₁-V_{M} may be aligned in a bar-pattern or a diamond-pattern. However, it is for illustrative purpose only and not meant to be a limitation of the present invention.

In addition, the control circuit 140 is coupled to the capacitive touch panel 120. The control circuit 140 includes, but not limited to, a receiving unit 142, a processing unit 144 and a determining unit 146. The receiving unit 142 is arranged for receiving the self-sensing signals S₁-S_{M+N} from the capacitive touch panel 120. The processing unit 144 is coupled to the receiving unit 142, and arranged for generating a sensing value SV according to the self-sensing signals S₁-S_{M+N}. The determining unit 146 is coupled to the processing unit 144, and arranged for comparing the sensing value SV with a predetermined threshold TH to determine whether there is an object approaching the capacitive touch panel 120.

Please note that, since the plurality of traces H₁-H_{N} and V₁-V_{M} are substantially capacitors, magnitude of the self-sensing signals S₁-S_{M+N} generated due to approaching of the object OB (e.g., a user's face) is inversely proportional to the square of the distance between the object OB (e.g., a user's face) and the capacitive touch panel 120. That is, the self-sensing signals S₁-S_{M+N} obtained at the time the object OB (e.g., a user's face) touches the capacitive touch panel 120 will be significantly larger than that obtained at the time the object OB (e.g., a user's face) only approaches the capacitive touch panel 120. In other words, it is engineered that the self-sensing signals S₁-S_{M+N} are significant only when the object OB (e.g., a user's face) actually touches the capacitive touch panel 120.

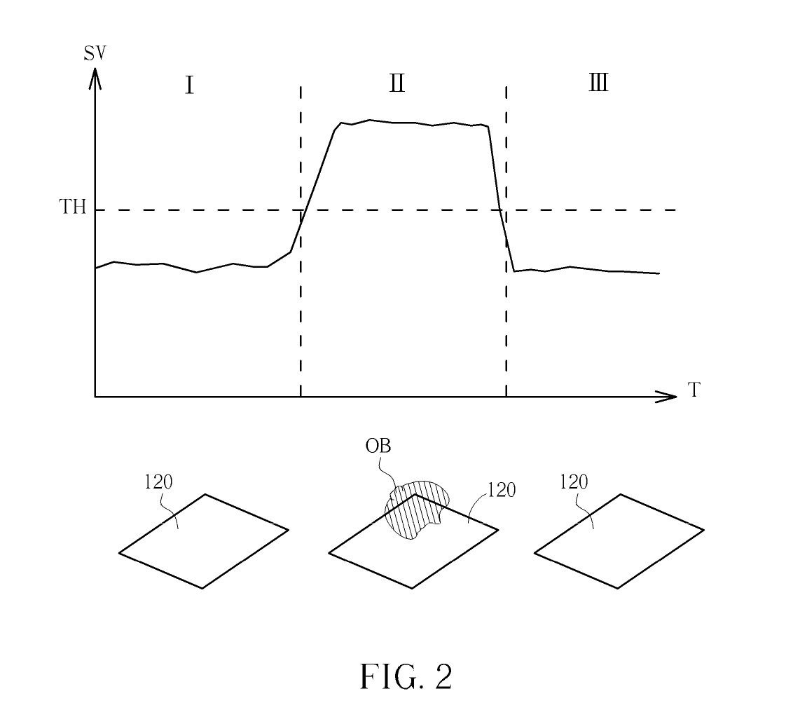

Therefore, in order to obtain a distinguishable result from the insignificant self-sensing signals S₁-S_{M+N} when the object OB (e.g., a user's face) approaches but not actually touches the capacitive touch panel 120, the control circuit 140 generates the sensing value SV corresponding to a summation of the plurality of self-sensing signals S₁-S_{M+N}, and compares the sensing value SV with the predetermined threshold TH to determine whether the object OB (e.g., a user's face) approaches the capacitive touch panel 120. Please refer to FIG. 2, which is a schematic diagram illustrating the decision making of the control circuit 140 according to an embodiment of the present invention. In FIG. 2, when the object OB (e.g., a user's face) approaches the capacitive touch panel 120 (from region I into region II), the sensing value SV rises and exceeds the predetermined threshold TH, and then the control circuit 140 determines that the object OB (e.g., a user's face) approaches the capacitive touch panel 120. On the other hand, when the object OB (e.g., a user's face) leaves the capacitive touch panel 120 (from region II into region III), the sensing value SV drops below the predetermined threshold TH, and then the control circuit 140 determines that there is no object approaching the capacitive touch panel 120.

Besides, when the control circuit 140 determines the object OB (e.g., a user's face) approaches the capacitive touch panel 120, the touch-sensing device 100 may turn off a backlight of the touch-sensing device 100 to conserve power consumption and/or temporarily disable the touch-sensing function to avoid inadvertent touch operations.

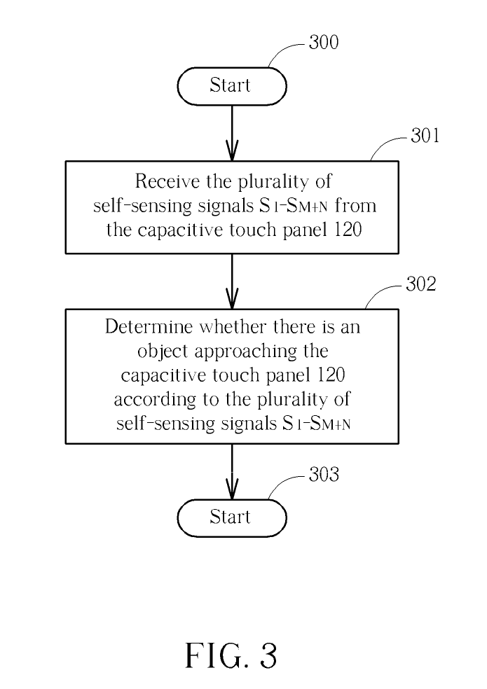

Please refer to FIG. 3, which is a flowchart of a proximity detection method according to an embodiment of the present invention. Please note that if the result is substantially the same, the steps are not required to be executed in the exact order shown in FIG. 3. The exemplary proximity detection method may be employed by the touch-sensing device 100, and may be briefly summarized by the following steps.

Step 300: Start.

Step 301: Receive the plurality of self-sensing signals S₁-S_{M+N} from the capacitive touch panel 120.

Step 302: Determine whether there is an object approaching the capacitive touch panel 120 according to the plurality of self-sensing signals S₁-S_{M+N.}

Step 303: End.

The proximity detection method illustrates the operations of the touch-sensing device 100. As details of each step in FIG. 3 can be readily known by referring to the detailed description directed to the touch-sensing device 100, further description is omitted here for brevity.

To sum up, the present invention provides a proximity detection function implemented by using a capacitive touch panel. Hence, the proposed proximity detection design may be applied to a variety of applications without raising additional hardware costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch-sensing device with a proximity detection function, comprising:
a capacitive touch panel, arranged for generating a plurality of self-sensing signals via a plurality of traces, respectively; and
a control circuit, coupled to the capacitive touch panel, for receiving the plurality of self-sensing signals from the capacitive touch panel, and determining whether there is an object approaching the capacitive touch panel according to the plurality of self-sensing signals.

2. The touch-sensing device of claim 1, wherein the control circuit generates a sensing value corresponding to a summation of the plurality of self-sensing signals, and compares the sensing value with a predetermined threshold to determine whether the object approaches the capacitive touch panel.

3. The touch-sensing device of claim 2, wherein the control circuit determines that there is no object approaching the capacitive touch panel when the sensing value is smaller than the predetermined threshold.

4. The touch-sensing device of claim 2, wherein the control circuit determines that the object is approaching the capacitive touch panel when the sensing value is larger than the predetermined threshold.

5. The touch-sensing device of claim 1, wherein the touch-sensing device further supports a user interface function, and the capacitive touch panel is further arranged to act as an interactive user interface.

6. A control circuit of a capacitive touch panel for proximity detection, comprising:
a receiving unit, arranged for receiving a plurality of self-sensing signals from the capacitive touch panel;
a processing unit, coupled to the receiving unit, for generating a sensing value corresponding to a summation of the plurality of self-sensing signals; and
a determining unit, coupled to the processing unit, for comparing the sensing value with a predetermined threshold to determine whether there is an object approaching the capacitive touch panel.

7. The control circuit of claim 6, wherein the determining unit determines that there is no object approaching the capacitive touch panel when the sensing value is smaller than the predetermined threshold.

8. The control circuit of claim 6, wherein the determining unit determines that the object is approaching the capacitive touch panel when the sensing value is larger than the predetermined threshold.

9. A proximity detection method, comprising:
receiving a plurality of self-sensing signals from a capacitive touch panel; and
determining whether there is an object approaching the capacitive touch panel according to the plurality of self-sensing signals.

10. The proximity detection method of claim 9, wherein the step of determining whether there is an object approaching the capacitive touch panel comprises:
generating a sensing value corresponding to a summation of the plurality of self-sensing signals; and
comparing the sensing value with a predetermined threshold to determine whether the object approaches the capacitive touch panel.
